(19) United States
(12) Patent Application Publication
(10) Pub. No.: US 2013/0113298 A1
(43) Pub. Date: May 9, 2013

(54) WIRELESS POWER TRANSMISSION SYSTEM AND METHOD BASED ON IMPEDANCE MATCHING CONDITION

(71) Applicants: Young Ho RYU, Yongin-si (KR); Eun Seok PARK, Yongin-si (KR); Sang Wook KWON, Seongnam-si (KR); Ki Young KIM, Yongin-si (KR); Nam Yun KIM, Seoul (KR); Dong Zo KIM, Yongin-si (KR); Yun Kwon PARK, Dongducheon-si (KR); Keum Su SONG, Seoul (KR); Chang Wook YOON, Seoul (KR); Jin Sung CHOI, Seoul (KR)

(72) Inventors: Young Ho RYU, Yongin-si (KR); Eun Seok PARK, Yongin-si (KR); Sang Wook KWON, Seongnam-si (KR); Ki Young KIM, Yongin-si (KR); Nam Yun KIM, Seoul (KR); Dong Zo KIM, Yongin-si (KR); Yun Kwon PARK, Dongducheon-si (KR); Keum Su SONG, Seoul (KR); Chang Wook YOON, Seoul (KR); Jin Sung CHOI, Seoul (KR)

(73) Assignee: Samsung Electronics Co., Ltd., Suwon-si (KR)

(21) Appl. No.: 13/671,027

(22) Filed: Nov. 7, 2012

(30) Foreign Application Priority Data
Nov. 8, 2011 (KR) 10-2011-0116026

(51) Int. Cl. H01F 38/14

(52) U.S. Cl. CPC H01F 38/14
USPC 307/104

(57) ABSTRACT

A wireless power transmission system and a method based on an impedance matching condition are provided. A source device of the wireless power transmission system, includes a power converter configured to generate power. The source device further includes a resonator configured to transmit the power to a target device. A ratio of an input impedance of the resonator to an output impedance of the power converter is less than a reference value.

### CROSS-REFERENCE TO RELATED APPLICATION(S)

This application claims the benefit under 35 U.S.C. §119(a) of Korean Patent Application No. 10-2011-0116026, filed on Nov. 8, 2011, in the Korean Intellectual Property Office, the entire disclosure of which is incorporated herein by reference for all purposes.

### BACKGROUND

1. Field

The following description relates to a wireless power transmission system and a method based on an impedance matching condition.

2. Description of Related Art

Wireless power refers to energy transferred from a wireless power transmitter to a wireless power receiver, for example, through magnetic coupling. A wireless power transmission system includes a source device and a target device. The source device wirelessly transmits power, and the target device wirelessly receives the power. The source device may be referred to as a wireless power transmitter, and the target device may be referred to as a wireless power receiver.

The source device includes a source resonator, and the target device includes a target resonator. Magnetic coupling or resonance coupling may be formed between the source resonator and the target resonator.

Due to characteristics of a wireless environment, a distance between a source device and a target device, or matching conditions to match a source resonator and a target resonator, may be changed, which may result in a change in a power transmission efficiency. Accordingly, there is a desire for a wireless power transmission system that maintains the power transmission efficiency.

### SUMMARY

In one general aspect, there is provided a source device of a wireless power transmission system, the source device including a power converter configured to generate power. The source device further includes a resonator configured to transmit the power to a target device. A ratio of an input impedance of the resonator to an output impedance of the power converter is less than a reference value.

The reference value may be determined based on a power transmission efficiency of the wireless power transmission system.

The source device may further include a matching network configured to perform impedance matching between the resonator and the target device based on a change in an impedance between the resonator and the target device.

The source device may further include a matching network configured to perform impedance matching between the resonator and the target device to maintain a value of a voltage standing wave ratio (VSWR) between the resonator and the target device to be less than 2.

The reference value may be greater than 0.5, and may be less than 2.

The source device may further include a matching network configured to perform impedance matching between the resonator and the target device. In an initial condition, the matching network may be further configured to maintain the input impedance of the resonator in a first quadrant or a fourth quadrant of a Smith chart. The initial condition may indicate that the target device is recognized to be in an open state.

In another general aspect there is provided a source device of a wireless power transmission system, the source device including a power converter configured to generate a power. The source device further includes a resonator configured to transmit the power to target devices. The source device further includes a matching network configured to perform impedance matching between the resonator and the target devices. A ratio of an input impedance of the resonator to an output impedance of the power converter is less than a reference value.

In still another general aspect, there is provided a target device of a wireless power transmission system, the target device including a resonator configured to receive and output power from a source device. The target device further includes a rectification unit configured to rectify the power output from the resonator. A ratio of an output impedance of the resonator to an input impedance of the rectification unit is less than a reference value.

The target device may further include a matching network configured to perform impedance matching between the resonator and the source device based on a change in an impedance between the resonator and the source device.

The target device may further include a matching network configured to perform impedance matching between the resonator and the source device to maintain a value of a voltage standing wave ratio (VSWR) between the resonator and the source device to be less than 2.

In yet another general aspect, there is provided a power transmission method of a wireless power transmission system, the power transmission method including generating, by a power converter, a power. The method further includes transmitting, by a resonator, the power to a target device. A ratio of an input impedance of the resonator to an output impedance of the power converter is less than a reference value.

The method may further include performing impedance matching between the resonator and the target device based on a change in an impedance between the resonator and the target device.

The method may further include performing impedance matching between the resonator and the target device to maintain a value of a voltage standing wave ratio (VSWR) between the resonator and the target device to be less than 2.

The method may further include performing impedance matching between the resonator and the target device. The method may further include maintaining, in an initial condition, the input impedance of the resonator in a first quadrant or a fourth quadrant of a Smith chart.

In another general aspect, there is provided a power transmission method of a wireless power transmission system, the power transmission method including generating, by a power converter, a power. The method further includes transmitting, by a resonator, the power to target devices. The method further includes performing impedance matching between the resonator and the target devices. A ratio of an input impedance of the resonator to an output impedance of the power converter is less than a reference value.

In still another general aspect, there is provided a power reception method of a wireless power transmission system, the power reception method including receiving, by a resonator, a power from a source device. The method further includes rectifying, by a rectification unit, the received power. A ratio of an output impedance of the resonator to an input impedance of the rectification unit is less than a reference value.

The method may further include performing impedance matching between the resonator and the source device based on a change in an impedance between the resonator and the source device.

The method may further include performing impedance matching between the resonator and the source device to maintain a value of a voltage standing wave ratio (VSWR) between the resonator and the source device to be less than 2.

Other features and aspects will be apparent from the following detailed description, the drawings, and the claims.

### BRIEF DESCRIPTION OF THE DRAWINGS

FIG. 1 is a diagram illustrating an example of a wireless power transmission system.

FIG. 2 is a diagram illustrating an example of a multi-target environment.

FIGS. 3 through 5 are diagrams illustrating examples of schemes of adjusting an impedance between a source resonator and a target resonator.

FIGS. 6A and 6B are diagrams illustrating an example of a wireless power transmitter.

FIG. 7A is a diagram illustrating an example of a distribution of a magnetic field within a source resonator based on feeding of a feeding unit.

FIG. 7B is a diagram illustrating examples of equivalent circuits of a feeding unit and a source resonator.

FIGS. 8 and 9 are diagrams illustrating examples of impedance matching of a wireless power transmission system.

FIG. 10 is a diagram illustrating an example of a matching network of a wireless power transmission system.

FIG. 11 is a diagram illustrating an example of a Smith chart to describe an impedance matching condition of a wireless power transmission system.

FIG. 12 is a diagram illustrating an example of an electric vehicle charging system.

FIGS. 13A through 14B are diagrams illustrating examples of applications in which a wireless power transmitter and a wireless power receiver are mounted.

FIG. 15 is a diagram illustrating an example of a wireless power transmitter and a wireless power receiver.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

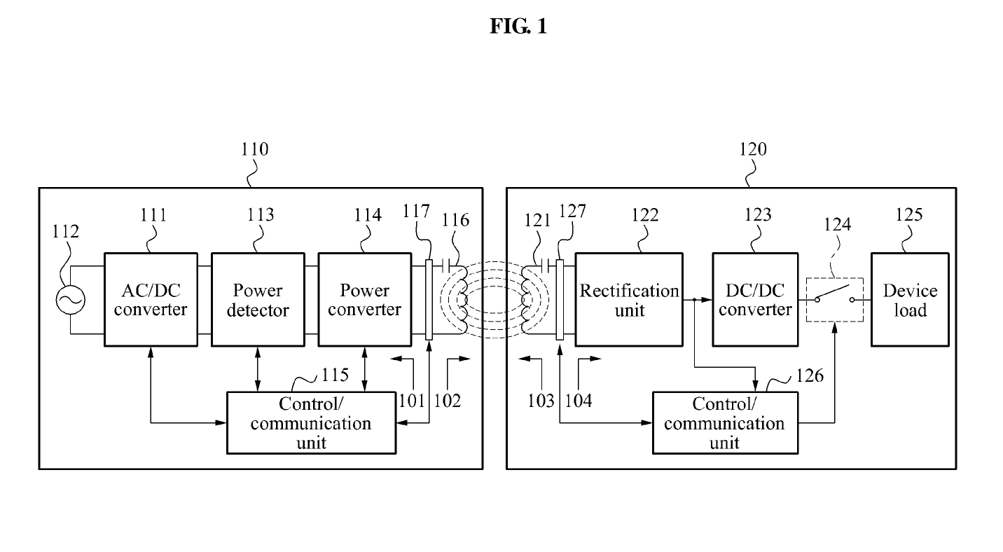

FIG. 1 illustrates an example of a wireless power transmission system. Referring to FIG. 1, the wireless power transmission and charging system includes a source device 110 and a target device 120. The source device 110 is a device supplying wireless power, and may be any of various devices that supply power, such as pads, terminals, televisions (TVs), and any other device that supplies power. The target device 120 is a device receiving wireless power, and may be any of various devices that consume power, such as terminals, TVs, vehicles, washing machines, radios, lighting systems, and any other device that consumes power.

The source device 110 includes an alternating current-to-direct current (AC/DC) converter 111, a power detector 113, a power converter 114, a control and communication (control/communication) unit 115, and a source resonator 116. Additionally, the source device 110 further includes a matching network 117.

The target device 120 includes a target resonator 121, a rectification unit 122, a DC-to-DC (DC/DC) converter 123, a switch unit 124, a device load 125, and a control/communication unit 126. Furthermore, the target device 120 further includes a matching network 127.

The AC/DC converter 111 generates a DC voltage by rectifying an AC voltage having a frequency of tens of hertz (Hz) output from a power supply 112. The AC/DC converter 111 may output a DC voltage having a predetermined level, or may output a DC voltage having an adjustable level by the control/communication unit 115.

The power detector 113 detects an output current and an output voltage of the AC/DC converter 111, and provides, to the control/communication unit 115, information on the detected current and the detected voltage. Additionally, the power detector 113 detects an input current and an input voltage of the power converter 114.

The power converter 114 generates a power by converting the DC voltage output from the AC/DC converter 111 to an AC voltage using a switching pulse signal having a frequency of a few kilohertz (kHz) to tens of megahertz (MHz). In other words, the power converter 114 converts a DC voltage supplied to a power amplifier to an AC voltage using a reference resonance frequency F_{Ref}, and generates a wake-up power to be used for activating or a charging power to be used for charging that may be used in a plurality of target devices. The wake-up power may be, for example, a low power of 0.1 to 1 milliwatts (mW) that may be used by a target device to perform communication, and the charging power may be, for example, a high power of 1 mW to 200 Watts (W) that may be consumed by a device load of a target device. In this description, the term “charging” may refer to supplying power to an element or a unit that charges a battery or other rechargeable device with power. Also, the term “charging” may refer supplying power to an element or a unit that consumes power. For example, the term “charging power” may refer to power consumed by a target device while operating, or power used to charge a battery of the target device. The unit or the element may include, for example, a battery, a display device, a sound output circuit, a main processor, and various types of sensors.

A ratio of an input impedance of the source resonator 116 to an output impedance of the power converter 114 may be less than a reference value. The reference value may be determined based on a charging power transmission efficiency. To maintain the charging power transmission efficiency above 90%, the reference value may need to be greater than 0.5 and less than 2. Hereinafter, the ratio of the input impedance of the source resonator 116 to the output impedance of the power converter 114 may be referred to as an impedance transformation ratio (ITR).

The output impedance of the power converter 114 may refer to an impedance viewed in a direction from the matching network 117 to the power converter 114, as indicated by an arrow 101 of FIG. 1. Additionally, the input impedance of the source resonator 116 may refer to an impedance viewed in a direction from the matching network 117 to the source resonator 116, as indicated by an arrow 102 of FIG. 1.

The control/communication unit 115 may detect a reflected wave of the communication power or a reflected wave of the charging power, and may detect mismatching between the target resonator 121 and the source resonator 116 based on the detected reflected wave. The control/communication unit 115 may detect the mismatching by detecting an envelope of the reflected wave, or by detecting an amount of a power of the reflected wave. The control/communication unit 115 may calculate a voltage standing wave ratio (VSWR) based on a voltage level of the reflected wave and a level of an output voltage of the source resonator 116 or the power converter 114. When the VSWR is greater than a predetermined value, the control/communication unit 115 detects the mismatching.

Also, the control/communication unit 115 may control a frequency of a switching pulse signal used by the power converter 114.

The control/communication unit 115 may perform out-of-band communication using a communication channel. The control/communication unit 115 may include a communication module, such as a ZigBee module, a Bluetooth module, or any other communication module, that the control/communication unit 115 may use to perform the out-of-band communication. The control/communication unit 115 may transmit or receive data to or from the target device 120 via the out-of-band communication.

The source resonator 116 transfers electromagnetic energy, such as the communication power or the charging power, to the target resonator 121 via a magnetic coupling with the target resonator 121.

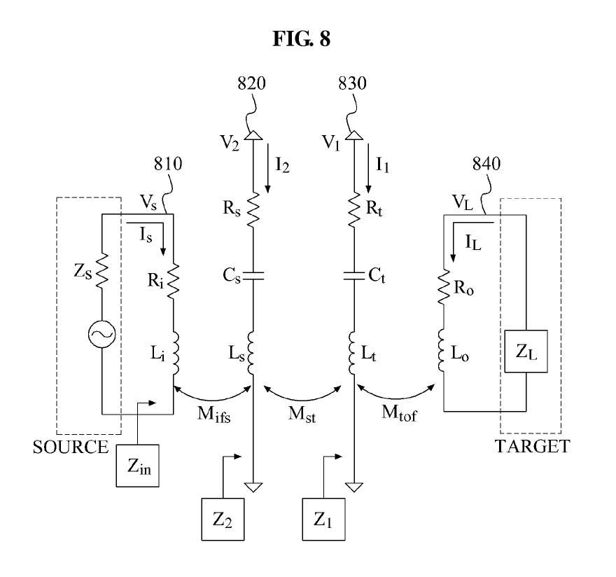

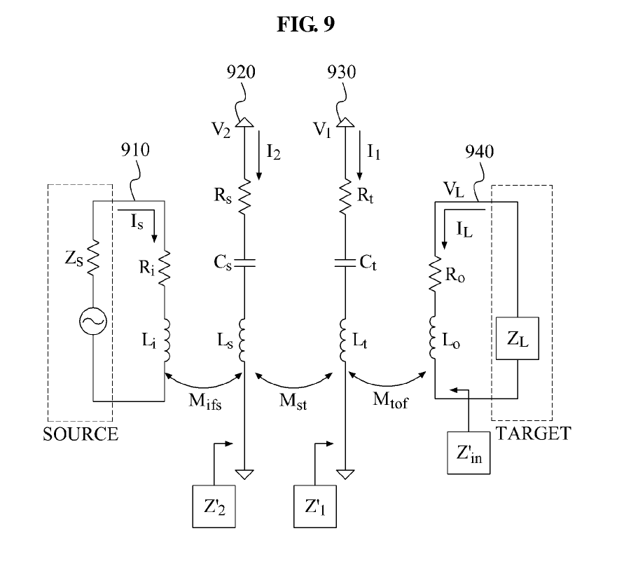

The matching network 117 performs impedance matching between the source resonator 116 and the target device 120. A characteristic of the matching network 117 will be further described with reference to FIGS. 8 through 10.

The target resonator 121 receives the electromagnetic energy, such as the wake-up power or the charging power, from the source resonator 116 via a magnetic coupling with the source resonator 116. The wake-up power is used to activate a communication function and a control function, and the charging power is used to perform charging.

The matching network 127 performs impedance matching between the target resonator 121 and the source device 110. A characteristic of the matching network 127 will be further described with reference to FIGS. 8 through 10.

The rectification unit 122 (i.e., a rectifier) generates a DC voltage by rectifying an AC voltage received by the target resonator 121.

A ratio of an output impedance of the target resonator 121 to an input impedance of the rectification unit 122 may be less than a reference value. The reference value may be determined based on the charging power transmission efficiency.

The input impedance of the rectification unit 122 may refer to an impedance viewed in a direction from the matching network 127 to the rectification unit 122, as indicated by an arrow 104 of FIG. 1. The output impedance of the target resonator 121 may refer to an impedance viewed in a direction from the matching network 127 to the target resonator 121, as indicated by an arrow 103 of FIG. 1.

The DC/DC converter 123 adjusts a level of the DC voltage output from the rectification unit 122 based on a voltage rating of the device load 125. For example, the DC/DC converter 123 may adjust the level of the DC voltage output from the rectification unit 122 to a level in a range from 3 volts (V) to 10 V.

The switch unit 124 is turned on or off by the control/communication unit 126. When the switch unit 124 is turned off, the control/communication unit 115 of the source device 110 may detect a reflected wave. In other words, when the switch unit 124 is turned off, the magnetic coupling between the source resonator 116 and the target resonator 121 is interrupted.

The device load 125 may include, for example, a battery, a display, a sound output circuit, a main processor, and/or various sensors. The device load 125 may charge the battery using the DC voltage output from the DC/DC converter 123.

The control/communication unit 126 is activated by the wake-up power. The control/communication unit 126 communicates with the source device 110, and controls an operation of the target device 120.

The rectification unit 122, the DC/DC converter 123, and the switch unit 124 of FIG. 1 may be referred to as power supply units. Accordingly, the target device 120 may include the target resonator 121 and the power supply units 122, 123 and 124 configured to supply the received power to the device load 125. The device load 125 may be expressed as a load.

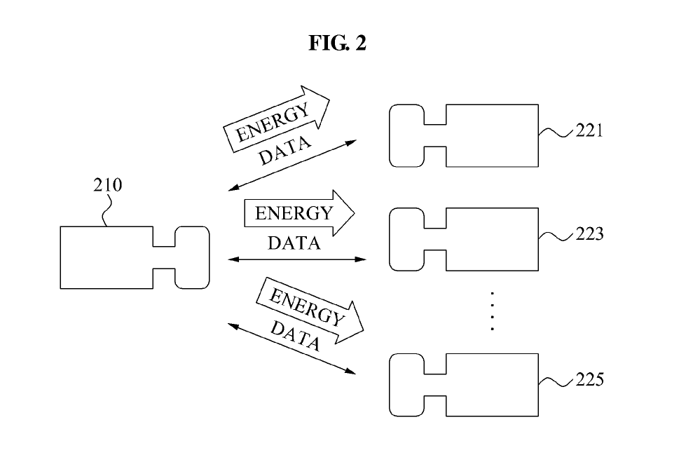

FIG. 2 illustrates an example of a multi-target environment. Referring to FIG. 2, a source device 210 simultaneously, wirelessly transfers energy and data to target devices, for example, target devices 221, 223, and 225. That is, based on a wireless power transmission employing a resonance scheme, the source device 210 simultaneously charges the target devices 221, 223, and 225.

The source device 210 may include the same structure as the source device 110 of FIG. 1. Additionally, each of the target devices 221, 223 and 225 may include the same structure as the target device 120 of FIG. 1.

A source resonator of the source device 210 transmits charging power to the target devices 221, 223 and 225. Additionally, a matching network of the source device 210 adaptively performs impedance matching between the source resonator and the target devices 221, 223 and 225.

The target devices 221, 223, and 225 may be of various types. For example, the target device 221 may be a smartphone, a tablet personal computer (PC), and/or an MP3 (Moving Picture Experts Group Audio Layer III) player. Additionally, the target devices 223 and 225 may be of the same type as, or a different type from, the target device 221.

In a single target environment (e.g., of FIG. 1), an impedance between a source resonator and a target resonator may be changed based on, for example, a distance between the source resonator and the target resonator, an angle formed by the source resonator and the target resonator, a relative position of the target resonator with respect to the source resonator, and/or other factors known to one of ordinary skill in the art. Additionally, while the single target environment is changed to a multi-target environment (e.g., of FIG. 2), an impedance between a source resonator and target resonators may be changed. The change in the impedance may be closely-related to a total efficiency of a wireless power transmission system.

In the single target environment and the multi-target environment, to obtain an optimum power transmission efficiency, at least one of three conditions described below may need to be satisfied.

[Condition 1]

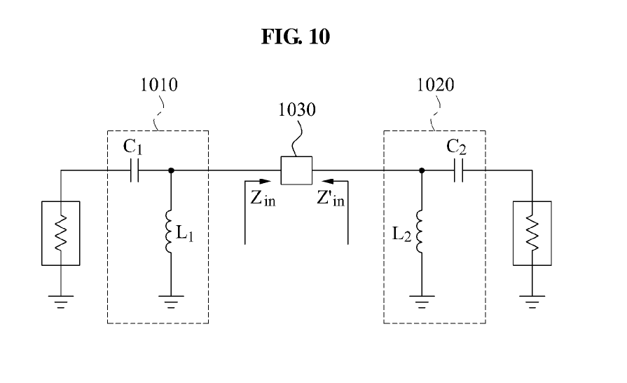

A value of an ITR of a source device and/or a target device is designed or predetermined to be close to 1. For example, the value of the ITR may be greater than 0.5 and less than 2. Condition 1 will be further described with reference to FIG. 10.

[Condition 2]

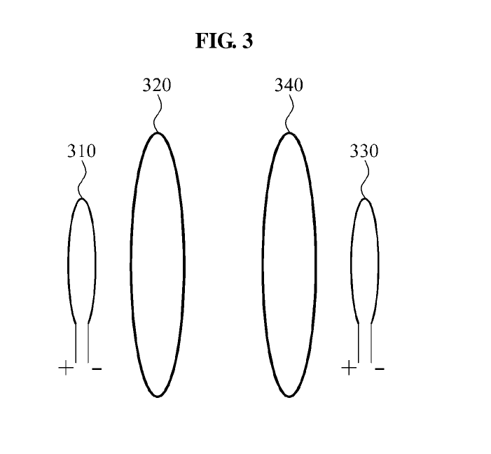

A value of a voltage stranding wave ratio (VSWR) between a source resonator and a target device is maintained to be less than 2. Condition 2 will be further described with reference to FIGS. 3 through 9.

[Condition 3]

In an initial condition, a matching network of a source device is designed or configured so that a large amount of power is transferred to a target device. The initial condition may indicate that the target device or a rectifier of the target device is recognized to be in an open state, i.e., turned on.

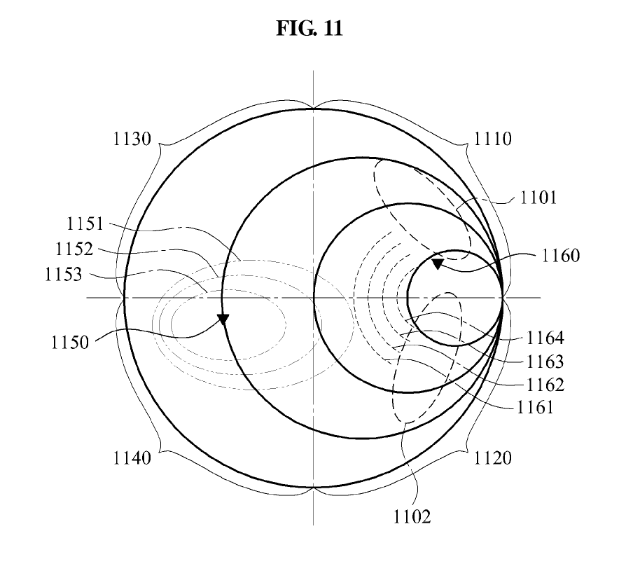

For example, in the initial condition, the matching network may be designed to maintain an input impedance of a source resonator to remain in a first quadrant or a fourth quadrant of a Smith chart. In another example, based on an operation characteristic of a power amplifier in a power converter of the source device, the input impedance of the source resonator may be maintained to remain in quadrants other than the first quadrant and the fourth quadrant of the Smith chart. For example, in the initial condition, if the input impedance of the source resonator remains in a second quadrant based on the operation characteristic of the power amplifier, a larger amount of power is transferred to the target device. Condition 3 will be further described with reference to FIG. 11.

In the wireless power transmission system, a matching network performs impedance matching. Various impedance matching schemes may exist, and will be described with reference to examples below.

FIGS. 3 through 5 illustrate examples of schemes of adjusting an impedance between a source resonator and a target resonator. Referring to FIG. 3, an impedance between a source resonator 320 and a target resonator 340 may be adjusted based on sizes of feeders 310 and 330, and a distance between the source resonator 320 and the target resonator 340.

However, it is difficult to perform impedance matching in real time based on the sizes of the feeders 310 and 330, and the distance between the source resonator 320 and the target resonator 340. Accordingly, the impedance matching may need to be performed adaptively based on a change in impedance, using a matching network.

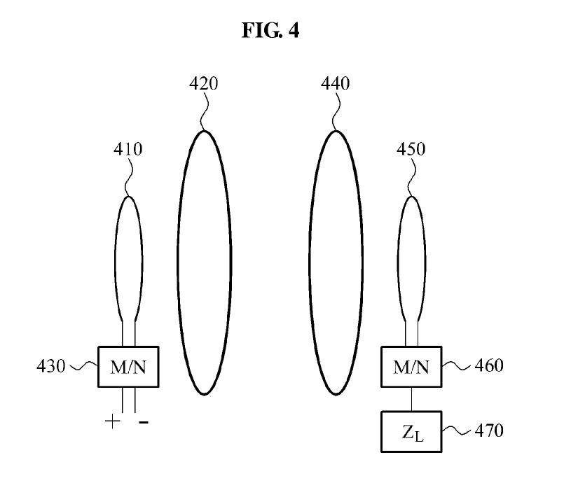

Referring to FIG. 4, impedance matching between a source resonator 420 and a target resonator 440 may be performed using matching networks (M/N) 430 and 460 respectively connected to feeders 410 and 450. For example, an impedance between the source resonator 420 and the target resonator 440 may be changed based on a change in a load (Z_{L}) 470. In this example, each of the matching networks 430 and 460 includes an adaptive circuit configured to perform impedance matching adaptively based on a change in the impedance between the source resonator 420 and the target resonator 440.

The adaptive circuit may include, for example, a circuit configured to turn on an element, such as a capacitor or an inductor, using switches. The switches may include, for example, electrical switches, microelectromechanical systems (MEMS) switches, and/or relay switches. Additionally, the adaptive circuit may include a resonance transmission line, and/or an active element, such as, for example, a varactor.

As described above, a wide variety of schemes may be used to adaptively perform impedance matching. However, the impedance matching needs to be performed to satisfy condition 2.

For convenience of description, for example, when a source device determines a VSWR in real time, and the VSWR is greater than 2, a capacitance or an inductance of a matching network may be changed. That is, a capacitance value or an inductance value of the matching network may be determined to maintain the VSWR to be less than 2, while continuing to change the capacitance or the inductance.

In this example, the source device may determine the VSWR using a reflected wave. Additionally, the source device and a target device may transmit and receive information used to determine the VSWR via communication.

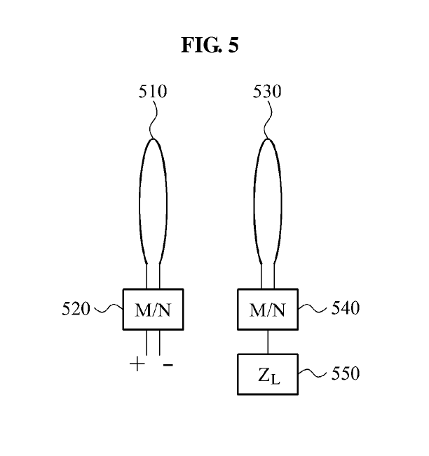

Referring to FIG. 5, matching networks (M/N) 520 and 540 are connected directly to a source resonator 510 and a target resonator 530, respectively. An impedance between the source resonator 510 and the target resonator 530 may be changed based on various causes and/or a change in a load (Z_{L}) 550. Similarly to the matching networks 430 and 460 of FIG. 4, each of the matching networks 520 and 540 includes an adaptive circuit configured to perform impedance matching adaptively based on a change in the impedance between the source resonator 510 and the target resonator 530.

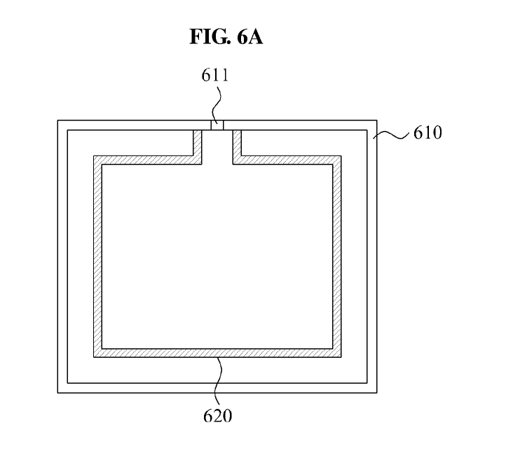

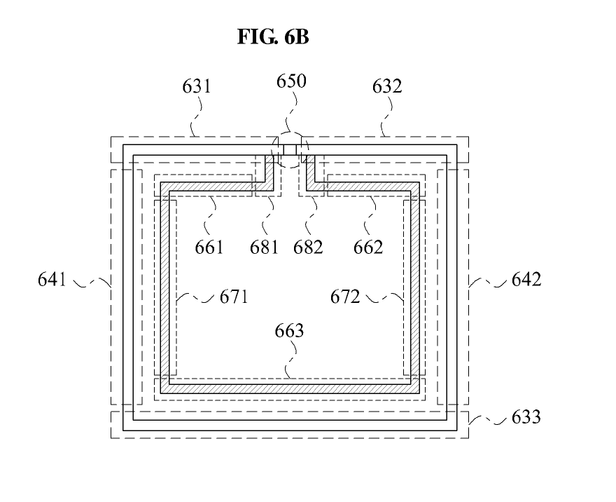

FIGS. 6A and 6B are diagrams illustrating an example of a wireless power transmitter. Referring to FIG. 6A, the wireless power transmitter includes a source resonator 610 and a feeding unit 620. The source resonator 610 further includes a capacitor 611. The feeding unit 620 is electrically connected to both ends of the capacitor 611.

FIG. 6B illustrates, in greater detail, a structure of the wireless power transmitter of FIG. 6A. The source resonator 610 includes a first transmission line (not identified by a reference numeral in FIG. 6B, but formed by various elements in FIG. 6B as discussed below), a first conductor 641, a second conductor 642, and at least one capacitor 650.

The capacitor 650 is inserted in series between a first signal conducting portion 631 and a second signal conducting portion 632, causing an electric field to be confined within the capacitor 650. Generally, a transmission line includes at least one conductor in an upper portion of the transmission line, and at least one conductor in a lower portion of first transmission line. A current may flow through the at least one conductor disposed in the upper portion of the first transmission line, and the at least one conductor disposed in the lower portion of the first transmission line may be electrically grounded. In this example, a conductor disposed in an upper portion of the first transmission line in FIG. 6B is separated into two portions that will be referred to as the first signal conducting portion 631 and the second signal conducting portion 632. A conductor disposed in a lower portion of the first transmission line in FIG. 6B will be referred to as a first ground conducting portion 633.

As illustrated in FIG. 6B, the source resonator 610 has a generally two-dimensional (2D) structure. The first transmission line includes the first signal conducting portion 631 and the second signal conducting portion 632 in the upper portion of the first transmission line, and includes the first ground conducting portion 633 in the lower portion of the first transmission line. The first signal conducting portion 631 and the second signal conducting portion 632 are disposed to face the first ground conducting portion 633. A current flows through the first signal conducting portion 631 and the second signal conducting portion 632.

One end of the first signal conducting portion 631 is connected to one end of the first conductor 641, the other end of the first signal conducting portion 631 is connected to the capacitor 650, and the other end of the first conductor 641 is connected to one end of the first ground conducting portion 633. One end of the second signal conducting portion 632 is connected to one end of the second conductor 642, the other end of the second signal conducting portion 632 is connected to the other end of the capacitor 650, and the other end of the second conductor 642 is connected to the other end of the ground conducting portion 633. Accordingly, the first signal conducting portion 631, the second signal conducting portion 632, the first ground conducting portion 633, the first conductor 641, and the second conductor 642 are connected to each other, causing the source resonator 610 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

The capacitor 650 is inserted into an intermediate portion of the first transmission line. In the example in FIG. 6B, the capacitor 650 is inserted into a space between the first signal conducting portion 631 and the second signal conducting portion 632. The capacitor 650 may be a lumped element capacitor, a distributed capacitor, or any other type of capacitor known to one of ordinary skill in the art. For example, a distributed element capacitor may include a zigzagged conductor line and a dielectric material having a relatively high permittivity disposed between parallel portions of the zigzagged conductor line.

The capacitor 650 inserted into the first transmission line may cause the source resonator 610 to have a characteristic of a metamaterial. A metamaterial is a material having a predetermined electrical property that is not found in nature, and thus may have an artificially designed structure. All materials existing in nature have a magnetic permeability and permittivity. Most materials have a positive magnetic permeability and/or a positive permittivity.

For most materials, a right-hand rule may be applied to an electric field, a magnetic field, and a Poynting vector of the materials, so the materials may be referred to as right-handed materials (RHMs). However, a metamaterial that has a magnetic permeability and/or a permittivity that is not found in nature, and may be classified into an epsilon negative (ENG) material, a mu negative (MNG) material, a double negative (DNG) material, a negative refractive index (NRI) material, a left-handed (LH) material, and other metamaterial classifications known to one of ordinary skill in the art based on a sign of the magnetic permeability of the metamaterial and a sign of the permittivity of the metamaterial.

If the capacitor 650 is a lumped element capacitor and a capacitance of the capacitor 650 is appropriately determined, the source resonator 610 may have a characteristic of a metamaterial. If the source resonator 610 is caused to have a negative magnetic permeability by appropriately adjusting the capacitance of the capacitor 650, the source resonator 610 may also be referred to as an MNG resonator. Various criteria may be applied to determine the capacitance of the capacitor 650. For example, the various criteria may include a criterion for enabling the source resonator 610 to have the characteristic of the metamaterial, a criterion for enabling the source resonator 610 to have a negative magnetic permeability at a target frequency, a criterion for enabling the source resonator 610 to have a zeroth order resonance characteristic at the target frequency, and any other suitable criterion. Based on any one or any combination of the aforementioned criteria, the capacitance of the capacitor 650 may be appropriately determined.

The source resonator 610, hereinafter referred to as the MNG resonator 610, may have a zeroth order resonance characteristic of having a resonance frequency when a propagation constant is “0”. If the MNG resonator 610 has the zeroth order resonance characteristic, the resonance frequency is independent of a physical size of the MNG resonator 610. By changing the capacitance of the capacitor 650, the resonance frequency of the MNG resonator 610 may be changed without changing the physical size of the MNG resonator 610.

In a near field, the electric field is concentrated in the capacitor 650 inserted into the first transmission line, causing the magnetic field to become dominant in the near field. The MNG resonator 610 has a relatively high Q-factor when the capacitor 650 is a lumped element, thereby increasing a power transmission efficiency. The Q-factor indicates a level of an ohmic loss or a ratio of a reactance with respect to a resistance in the wireless power transmission. As will be understood by one of ordinary skill in the art, the efficiency of the wireless power transmission will increase as the Q-factor increases.

Although not illustrated in FIG. 6B, a magnetic core passing through the MNG resonator 610 may be provided to increase a power transmission distance.

Referring to FIG. 6B, the feeding unit 620 includes a second transmission line (not identified by a reference numeral in FIG. 6B, but formed by various elements in FIG. 6B as discussed below), a third conductor 671, a fourth conductor 672, a fifth conductor 681, and a sixth conductor 682.

The second transmission line includes a third signal conducting portion 661 and a fourth signal conducting portion 662 in an upper portion of the second transmission line, and includes a second ground conducting portion 663 in a lower portion of the second transmission line. The third signal conducting portion 661 and the fourth signal conducting portion 662 are disposed to face the second ground conducting portion 663. A current flows through the third signal conducting portion 661 and the fourth signal conducting portion 662.

One end of the third signal conducting portion 661 is connected to one end of the third conductor 671, the other end of the third signal conducting portion 661 is connected to one end of the fifth conductor 681, and the other end of the third conductor 671 is connected to one end of the second ground conducting portion 663. One end of the fourth signal conducting portion 662 is connected to one end of the fourth conductor 672, the other end of the fourth signal conducting portion 662 is connected to one end the sixth conductor 682, and the other end of the fourth conductor 672 is connected to the other end of the second ground conducting portion 663. The other end of the fifth conductor 681 is connected to the first signal conducting portion 631 at or near where the first signal conducting portion 631 is connected to one end of the capacitor 650, and the other end of the sixth conductor 682 is connected to the second signal conducting portion 632 at or near where the second signal conducting portion 632 is connected to the other end of the capacitor 650. Thus, the fifth conductor 681 and the sixth conductor 682 are connected in parallel to both ends of the capacitor 650. The fifth conductor 681 and the sixth conductor 682 are used as an input port to receive an RF signal as an input.

Accordingly, the third signal conducting portion 661, the fourth signal conducting portion 662, the second ground conducting portion 663, the third conductor 671, the fourth conductor 672, the fifth conductor 681, the sixth conductor 682, and the source resonator 610 are connected to each other, causing the source resonator 610 and the feeding unit 620 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

If an RF signal is input to the fifth conductor 681 or the sixth conductor 682, input current flows through the feeding unit 620 and the source resonator 610, generating a magnetic field that induces a current in the source resonator 610. A direction of the input current flowing through the feeding unit 620 is identical to a direction of the induced current flowing through the source resonator 610, thereby causing a strength of a total magnetic field to increase in the center of the source resonator 610, and decrease near the outer periphery of the source resonator 610.

An input impedance is determined by an area of a region between the source resonator 610 and the feeding unit 620. Accordingly, a separate matching network used to match the input impedance to an output impedance of a power amplifier may not be necessary. However, if a matching network is used, the input impedance may be adjusted by adjusting a size of the feeding unit 620, and accordingly a structure of the matching network may be simplified. The simplified structure of the matching network may reduce a matching loss of the matching network.

The second transmission line, the third conductor 671, the fourth conductor 672, the fifth conductor 681, and the sixth conductor 682 of the feeding unit may have a structure identical to the structure of the source resonator 610. For example, if the source resonator 610 has a loop structure, the feeding unit 620 may also have a loop structure. As another example, if the source resonator 610 has a circular structure, the feeding unit 620 may also have a circular structure.

The configuration of the source resonator 610 and the configuration of the feeding unit 620, as described above, may equally be applied to a target resonator and a feeding unit of the target resonator, of a wireless power receiver.

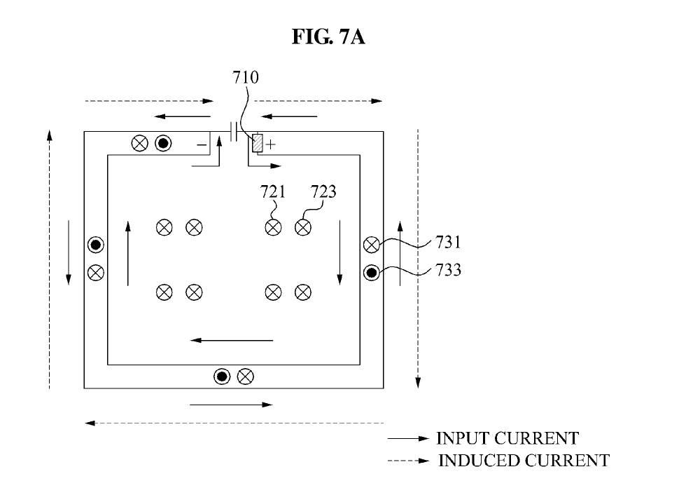

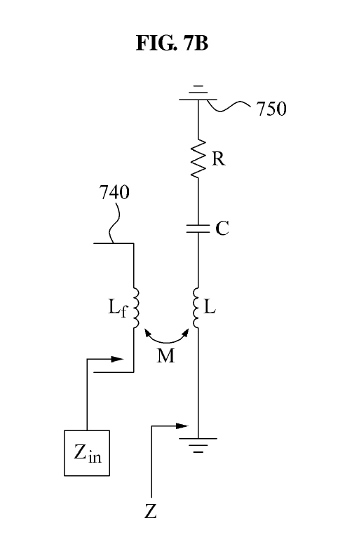

FIG. 7A is a diagram illustrating an example of a distribution of a magnetic field within a source resonator based on feeding of a feeding unit. FIG. 7A more simply illustrates the source resonator 610 and the feeding unit 620 of FIGS. 6A and 6B, and the names of the various elements in FIG. 6B will be used in the following description of FIG. 7A without reference numerals.

A feeding operation may be an operation of supplying power to a source resonator in wireless power transmission, or an operation of supplying AC power to a rectification unit in wireless power transmission. FIG. 7A illustrates a direction of input current flowing in the feeding unit, and a direction of induced current flowing in the source resonator. Additionally, FIG. 7A illustrates a direction of a magnetic field formed by the input current of the feeding unit, and a direction of a magnetic field formed by the induced current of the source resonator.

Referring to FIG. 7A, the fifth conductor or the sixth conductor of the feeding unit 620 may be used as an input port 710. In FIG. 7A, the sixth conductor of the feeding unit is being used as the input port 710. An RF signal is input to the input port 710. The RF signal may be output from a power amplifier. The power amplifier may increase and decrease an amplitude of the RF signal based on a power requirement of a target device. The RF signal input to the input port 710 is represented in FIG. 7A as an input current flowing in the feeding unit. The input current flows in a clockwise direction in the feeding unit along the second transmission line of the feeding unit. The fifth conductor and the sixth conductor of the feeding unit are electrically connected to the source resonator. More specifically, the fifth conductor of the feeding unit is connected to the first signal conducting portion of the source resonator, and the sixth conductor of the feeding unit is connected to the second signal conducting portion of the source resonator. Accordingly, the input current flows in both the source resonator and the feeding unit. The input current flows in a counterclockwise direction in the source resonator along the first transmission line of the source resonator. The input current flowing in the source resonator generates a magnetic field, and the magnetic field induces a current in the source resonator due to the magnetic field. The induced current flows in a clockwise direction in the source resonator along the first transmission line of the source resonator. The induced current in the source resonator transfers energy to the capacitor of the source resonator, and also generates a magnetic field. In FIG. 7A, the input current flowing in the feeding unit and the source resonator is indicated by solid lines with arrowheads, and the induced current flowing in the source resonator is indicated by dashed lines with arrowheads.

A direction of a magnetic field generated by a current is determined based on the right-hand rule. As illustrated in FIG. 7A, within the feeding unit, a direction 721 of the magnetic field generated by the input current flowing in the feeding unit is identical to a direction 723 of the magnetic field generated by the induced current flowing in the source resonator. Accordingly, a strength of the total magnetic field may increases inside the feeding unit.

In contrast, as illustrated in FIG. 7A, in a region between the feeding unit and the source resonator, a direction 733 of the magnetic field generated by the input current flowing in the feeding unit is opposite to a direction 731 of the magnetic field generated by the induced current flowing in the source resonator. Accordingly, the strength of the total magnetic field decreases in the region between the feeding unit and the source resonator.

Typically, in a source resonator having a loop structure, a strength of a magnetic field decreases in the center of the source resonator, and increases near an outer periphery of the source resonator. However, referring to FIG. 7A, since the feeding unit is electrically connected to both ends of the capacitor of the source resonator, the direction of the induced current in the source resonator is identical to the direction of the input current in the feeding unit. Since the direction of the induced current in the source resonator is identical to the direction of the input current in the feeding unit, the strength of the total magnetic field increases inside the feeding unit, and decreases outside the feeding unit. As a result, due to the feeding unit, the strength of the total magnetic field increases in the center of the source resonator having the loop structure, and decreases near an outer periphery of the source resonator, thereby compensating for the normal characteristic of the source resonator having the loop structure in which the strength of the magnetic field decreases in the center of the source resonator, and increases near the outer periphery of the source resonator. Thus, the strength of the total magnetic field may be constant inside the source resonator.

A power transmission efficiency for transferring wireless power from a source resonator to a target resonator is proportional to the strength of the total magnetic field generated in the source resonator. Accordingly, when the strength of the total magnetic field increases inside the source resonator, the power transmission efficiency also increases.

FIG. 7B is a diagram illustrating examples of equivalent circuits of a feeding unit and a source resonator. Referring to FIG. 7B, a feeding unit 740 and a source resonator 750 may be represented by the equivalent circuits in FIG. 7B. The feeding unit 740 is represented as an inductor having an inductance L_{f}, and the source resonator 750 is represented as a series connection of an inductor having an inductance L coupled to the inductance L_{f} of the feeding unit 740 by a mutual inductance M, a capacitor having a capacitance C, and a resistor having a resistance R. An example of an input impedance Zᵢₙ viewed in a direction from the feeding unit 740 to the source resonator 750 may be expressed by the following Equation 4:

$${Z}_{in} = \frac{{( ω M )}^{2}}{Z} \qquad ( 1 )$$

In Equation 4, M denotes a mutual inductance between the feeding unit 740 and the source resonator 750, ω denotes a resonance frequency of the feeding unit 740 and the source resonator 750, and Z denotes an impedance viewed in a direction from the source resonator 750 to a target device. As can be seen from Equation 4, the input impedance Zᵢₙ is proportional to the square of the mutual inductance M. Accordingly, the input impedance Zᵢₙ may be adjusted by adjusting the mutual inductance M. The mutual inductance M depends on an area of a region between the feeding unit 740 and the source resonator 750. The area of the region between the feeding unit 740 and the source resonator 750 may be adjusted by adjusting a size of the feeding unit 740, thereby adjusting the mutual inductance M and the input impedance Zᵢₙ.

In a target resonator and a feeding unit included in a wireless power receiver, a magnetic field may be distributed as illustrated in FIG. 7A. For example, the target resonator may receive wireless power from a source resonator via magnetic coupling. The received wireless power induces a current in the target resonator. The induced current in the target resonator generates a magnetic field, which induces a current in the feeding unit. If the target resonator is connected to the feeding unit as illustrated in FIG. 7A, a direction of the induced current flowing in the target resonator will be identical to a direction of the induced current flowing in the feeding unit. Accordingly, for the reasons discussed above in connection with FIG. 7A, a strength of the total magnetic field will increase inside the feeding unit, and will decrease in a region between the feeding unit and the target resonator.

FIGS. 8 and 9 illustrate examples of impedance matching of a wireless power transmission system. Referring to FIG. 8, Zᵢₙ indicates an input impedance of a source resonator 820, Z₂ indicates an impedance between a feeder 810 of the source resonator 820 and the source resonator 820, and Z₁ indicates an impedance between the source resonator 820 and a target resonator 830.

The impedances Z₁ and Z₂ may be expressed by the following Equations 2 and 3:

$$\begin{matrix}{Z}_{1} \approx {R}_{t} + \frac{{ω}^{2} {M}_{tof}^{2}}{{R}_{o} + {Z}_{L}} & ( 2 ) \\ {Z}_{2} = {R}_{s} + \frac{{ω}^{2} {M}_{st}^{2}}{{Z}_{2}} & ( 3 )\end{matrix}$$

In Equations 2 and 3, Rₜ denotes a resistance of the target resonator 830, denotes an angular speed of a resonance frequency, M_{tof} denotes a mutual inductance between a feeder 840 of the target resonator 830 and the target resonator 830, Rₒ denotes a resistance of the feeder 840, R_{S} denotes a resistance of the source resonator 820, and Mₛₜ denotes a mutual inductance between the source resonator 820 and the target resonator 830.

The input impedance Zᵢₙ may be expressed by the following Equation 4:

$${Z}_{in} \approx {R}_{i} + \frac{{ω}^{2} {M}_{ifs}^{2}}{{Z}_{2}} \qquad ( 4 )$$

In Equation 4, Rᵢ denotes a resistance of the feeder 810, and M_{ifs} denotes a mutual inductance between the feeder 810 and the source resonator 820.

FIG. 9 illustrates impedances associated with a target device. In FIG. 9, Z′ᵢₙ indicates an output impedance of a target resonator 920, Z′₂ indicates an impedance between a feeder 910 of the target resonator 920 and the target resonator 920, and Z′₁ indicates an impedance between a source resonator 930 and the target resonator 920.

The impedances Z′₁, Z′₂, and Z′ᵢₙ associated with the target device may be expressed by the following Equations 5 through 7:

$$\begin{matrix}{Z}_{1}^{′} = {R}_{s} + \frac{{ω}^{2} {M}_{ifs}^{2}}{{R}_{i} + {Z}_{S}} & ( 5 ) \\ {Z}_{2}^{′} = {R}_{t} + \frac{{ω}^{2} {M}_{st}^{2}}{{Z}_{1}^{′}} & ( 6 ) \\ {Z}_{in}^{′} = {R}_{o} + \frac{{ω}^{2} {M}_{tof}^{2}}{{Z}_{2}^{′}} & ( 7 )\end{matrix}$$

In Equations 5 through 7, Z_{S} denotes an impedance of a source device connected to a feeder 940.

Referring to Equations 2 through 7, impedance parameters of a wireless power transmission system may be generally determined based on a size of a feeder, a distance between a feeder and a resonator, a distance between resonators, and a load Z_{L} of a target device. Additionally, a resistance of a source resonator and/or a target resonator may be ignored due to an extremely small value of the resistance.

FIG. 10 illustrates an example of a matching network of a wireless power transmission system. Referring to FIG. 10, the wireless power transmission system includes a wireless power link 1030, a matching network 1010 of a source device, and a matching network 1020 of a target device.

The matching network 1010 is represented as a series connection of a capacitor including a capacitance C₁, and an inductor including an inductance of L₁, and the capacitor, the inductor, and the wireless power link 1030 are connected to each other at a node. The matching network 1020 is represented as a series connection of a capacitor including a capacitance C₂, and an inductor including an inductance of L₂, and the capacitor, the inductor, and the wireless power link 1030 are connected to each other at an opposite node. The matching networks 1010 and 1020 include input impedances Zᵢₙ and Z′ᵢₙ, respectively.

A predetermined ITR (e.g., close to a value of 1) may be applied to the target device, as well as the source device. In an example in which the ITR includes a minimum value, a total efficiency of the wireless power transmission system may increase. In another example in which a value of the ITR is less than or equal to 1, functions of the matching networks 1010 and 1020 may hardly be performed, and power dissipated by the matching networks 1010 and 1020 may be close to a value of 0.

If condition 2 is satisfied, and the ITR includes a large value, an intensity of current flowing in the matching networks 1010 and 1020 may increase. Accordingly, an element including one of the matching networks 1010 and 1020 may cause a loss in the total efficiency.

To satisfy condition 2, the matching networks 1010 and 1020 may perform impedance matching adaptively based on a change in an impedance between a source resonator of the source device and the target device. Additionally, to satisfy condition 2, the matching networks 1010 and 1020 may adaptively perform the impedance matching to maintain a value of a VSWR between the source resonator and the target device to be less than 2.

The matching network 1010 may be designed or configured to maintain the input impedance Zᵢₙ of the source resonator to remain in a first quadrant or a fourth quadrant of a Smith chart, in an initial condition. The initial condition may indicate that the target device or a rectifier of the target device is recognized to be in an open state. Hereinafter, the initial condition will be further described with reference to FIG. 11.

FIG. 11 illustrates an example of a Smith chart to describe an impedance matching condition of a wireless power transmission system. Referring to FIG. 11, the Smith chart is divided into a first quadrant 1110, a second quadrant 1130, a third quadrant 1140, and a fourth quadrant 1120 based on positions of distributed impedances.

In an example in which an input impedance of a source resonator is positioned in the first quadrant 1110 or the fourth quadrant 1120, as indicated by a circle 1160, a source device transmits high power to a target device, and condition 3 is satisfied. In this example, a distribution of contour lines 1161, 1162, 1163 and 1164 indicates that an amount of the power transmitted to the target device increases as a distance between the circle 1160 and each of the contour lines 1161, 1162, 1163 and 1164 decreases.

In another example in which the input impedance of the source resonator is positioned around a circle 1150 (e.g., in the second quadrant 1130), a power transmission efficiency may increase, and condition 3 may be satisfied. In this example, a distribution of contour lines 1151, 1152 and 1153 indicates that the power transmission efficiency increases as a distance between the circle 1150 and each of the contour lines 1151, 1152 and 1153 decreases.

For example, when a resonance is initialized between the source resonator and a target resonator, a rectifier of the target device may include an extremely high impedance. When a predetermined period of time elapses after the resonance is initialized, power is supplied to the rectifier, and the rectifier is turned on. Accordingly, in an initial condition, a matching network of the source device may need to be designed or configured so that a large amount of power is transferred to the target device. Furthermore, when the rectifier is turned on, the matching network may need to be designed or configured to satisfy condition 2. In other words, condition 3 may refer to a design condition of the matching network to satisfy condition 2 when the rectifier is turned on.

In an example in which the input impedance of the source resonator is maintained to remain in the first quadrant 1110 or the fourth quadrant 1120 of the Smith chart, in the initial condition, when the rectifier is turned on, condition 2 is satisfied. In another example in which the input impedance of the source resonator is positioned in a dotted circle 1101 or 1102, in the initial condition, when the rectifier is turned on, condition 2 is satisfied.

Schemes of positioning the input impedance of the source resonator in the first quadrant 1110 or the fourth quadrant 1120 in the initial condition may be combined in various combinations. For example, a value satisfying condition 3 may be determined by properly adjusting a resistance value of the input impedance of the source resonator. Additionally, based on an operation characteristic of a power amplifier in a power converter of the source device, the input impedance of the source resonator may be maintained to remain in quadrants other than the first quadrant 1110 and the fourth quadrant 1120 (e.g., the second quadrant 1130) of the Smith chart.

According to the teachings above, there is provided a wireless power transmission system maintaining a power transmission efficiency. Additionally, there is provided an operation condition of a source device and an operation condition of a target device that enables efficient impedance matching. Furthermore, there is provided a source device and a target device achieving a high power transmission efficiency in a multi-target environment.

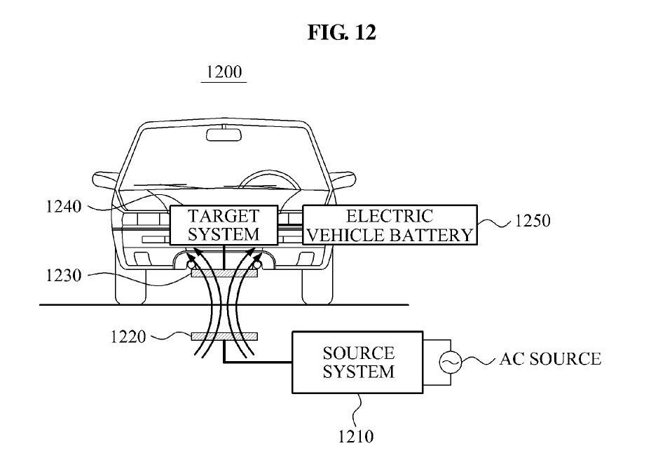

FIG. 12 illustrates an example of an electric vehicle charging system. Referring to FIG. 12, an electric vehicle charging system 1200 includes a source system 1210, a source resonator 1220, a target resonator 1230, a target system 1240, and an electric vehicle battery 1250.

In one example, the electric vehicle charging system 1200 has a structure similar to the structure of the wireless power transmission system of FIG. 1. The source system 1210 and the source resonator 1220 in the electric vehicle charging system 1200 operate as a source. The target resonator 1230 and the target system 1240 in the electric vehicle charging system 1200 operate as a target.

In one example, the source system 1210 includes an alternating current-to-direct current (AC/DC) converter, a power detector, a power converter, a control and communication (control/communication) unit similar to those of the source device 110 of FIG. 1. In one example, the target system 1240 includes a rectification unit, a DC-to-DC (DC/DC) converter, a switch unit, a charging unit, and a control/communication unit similar to those of the target device 120 of FIG. 1. The electric vehicle battery 1250 is charged by the target system 1240. The electric vehicle charging system 1200 may use a resonance frequency in a band of a few kHz to tens of MHz.

The source system 1210 generates power based on a type of the vehicle being charged, a capacity of the electric vehicle battery 1250, and a charging state of the electric vehicle battery 1250, and wirelessly transmits the generated power to the target system 1240 via a magnetic coupling between the source resonator 1220 and the target resonator 1230.

The source system 1210 may control an alignment of the source resonator 1220 and the target resonator 1230. For example, when the source resonator 1220 and the target resonator 1230 are not aligned, the controller of the source system 1210 may transmit a message to the target system 1240 to control the alignment of the source resonator 1220 and the target resonator 1230.

For example, when the target resonator 1230 is not located in a position enabling maximum magnetic coupling, the source resonator 1220 and the target resonator 1230 are not properly aligned. When a vehicle does not stop at a proper position to accurately align the source resonator 1220 and the target resonator 1230, the source system 1210 may instruct a position of the vehicle to be adjusted to control the source resonator 1220 and the target resonator 1230 to be aligned. However, this is just an example, and other methods of aligning the source resonator 1220 and the target resonator 1230 may be used.

The source system 1210 and the target system 1240 may transmit or receive an ID of a vehicle and exchange various messages by performing communication with each other.

The descriptions of FIGS. 2 through 11 are also applicable to the electric vehicle charging system 1200. However, the electric vehicle charging system 1200 may use a resonance frequency in a band of a few kHz to tens of MHz, and may wirelessly transmit power that is equal to or higher than tens of watts to charge the electric vehicle battery 1250.

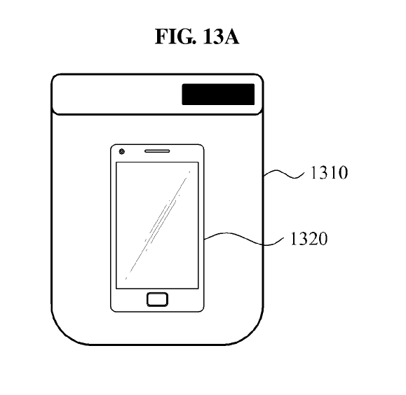

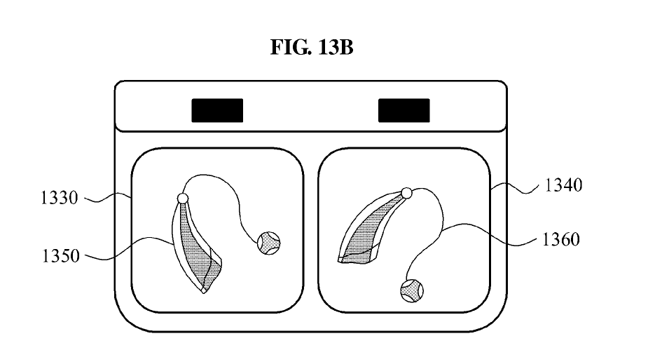

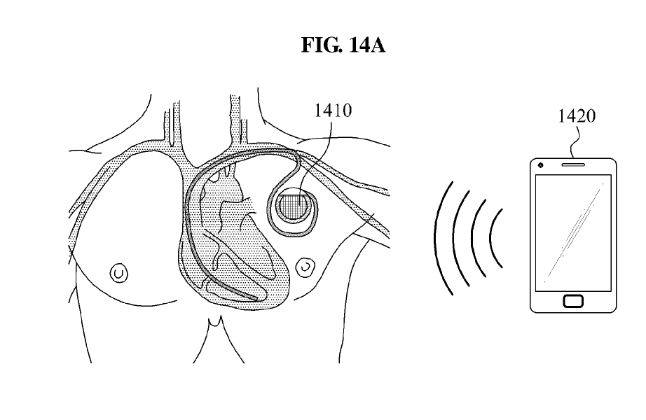

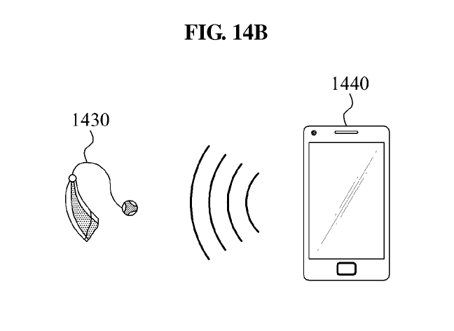

FIGS. 13A through 14B illustrate examples of applications in which a wireless power receiver and a wireless power transmitter are mounted. FIG. 13A illustrates an example of wireless power charging between a pad 1310 and a mobile terminal 1320, and FIG. 13B illustrates an example of wireless power charging between pads 1330 and 1340 and hearing aids 1350 and 1360, respectively.

Referring to FIG. 13A, a wireless power transmitter is mounted in the pad 1310, and a wireless power receiver is mounted in the mobile terminal 1320. The pad 1310 charges a single mobile terminal, namely, the mobile terminal 1320.

Referring to FIG. 13B, two wireless power transmitters are respectively mounted in the pads 1330 and 1340. The hearing aids 1350 and 1360 are used for a left ear and a right ear, respectively. Two wireless power receivers are respectively mounted in the hearing aids 1350 and 1360. The pads 1330 and 1340 charge two hearing aids, respectively, namely, the hearing aids 1350 and 1360.

FIG. 14A illustrates an example of wireless power charging between an electronic device 1410 inserted into a human body, and a mobile terminal 1420. FIG. 14B illustrates an example of wireless power charging between a hearing aid 1430 and a mobile terminal 1440.

Referring to FIG. 14A, a wireless power transmitter and a wireless power receiver are mounted in the mobile terminal 1420. Another wireless power receiver is mounted in the electronic device 1410. The electronic device 1410 is charged by receiving power from the mobile terminal 1420.

Referring to FIG. 14B, a wireless power transmitter and a wireless power receiver are mounted in the mobile terminal 1440. Another wireless power receiver is mounted in the hearing aid 1430. The hearing aid 1430 is charged by receiving power from the mobile terminal 1440. Low-power electronic devices, for example, Bluetooth earphones, may also be charged by receiving power from the mobile terminal 1440.

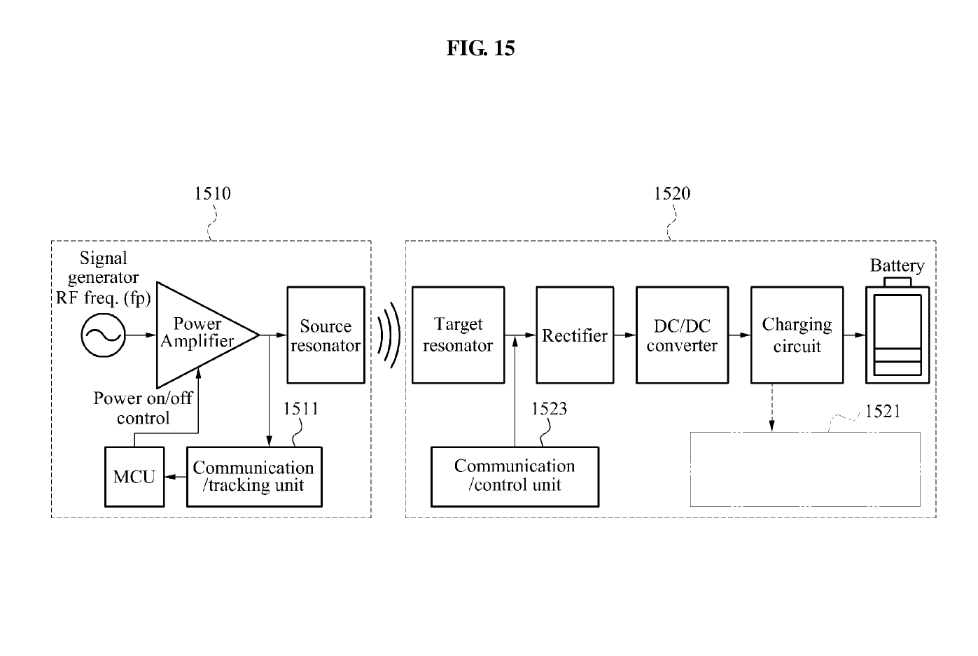

FIG. 15 illustrates an example of a wireless power transmitter and a wireless power receiver. Referring to FIG. 15, a wireless power transmitter 1510 may be mounted in each of the pad 1310 of FIG. 13A and pads 1330 and 1340 of FIG. 13B. Additionally, the wireless power transmitter 1510 may be mounted in each of the mobile terminal 1420 of FIG. 14A and the mobile terminal 1440 of FIG. 14B.

In addition, a wireless power receiver 1520 may be mounted in each of the mobile terminal 1320 of FIG. 13A and the hearing aids 1350 and 1360 of FIG. 13B. Further, the wireless power receiver 1520 may be mounted in each of the electronic device 1410 of FIG. 14A and the hearing aid 1430 of FIG. 14B.

The wireless power transmitter 1510 may include a similar configuration to the source device 110 of FIG. 1. For example, the wireless power transmitter 1510 may include a unit configured to transmit power using magnetic coupling.

Referring to FIG. 15, the wireless power transmitter 1510 includes a signal generator, a power amplifier, a microcontroller unit (MCU), a source resonator, and a communication/tracking unit 1511. The communication/tracking unit 1511 communicates with the wireless power receiver 1520, and controls an impedance and a resonance frequency to maintain a wireless power transmission efficiency. Additionally, the communication/tracking unit 1511 may perform similar functions to the power converter 114 and the control/communication unit 115 of FIG. 1.

The wireless power receiver 1520 may include a similar configuration to the target device 120 of FIG. 1. For example, the wireless power receiver 1520 may include a unit configured to wirelessly receive power and to charge a battery.

Referring to FIG. 15, the wireless power receiver 1520 includes a target resonator, a rectifier, a DC/DC converter, and a charging circuit. Additionally, the wireless power receiver 1520 includes a communication/control unit 1523. The communication/control unit 1523 communicates with the wireless power transmitter 1510, and performs an operation to protect overvoltage and overcurrent.

The wireless power receiver 1520 may include a hearing device circuit 1521. The hearing device circuit 1521 may be charged by a battery. The hearing device circuit 1521 may include a microphone, an analog-to-digital converter (ADC), a processor, a digital-to-analog converter (DAC), and a receiver. For example, the hearing device circuit 1521 may include the same configuration as a hearing aid.

The units described herein may be implemented using hardware components, software components, or a combination thereof. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable recording mediums. The computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments accomplishing the examples disclosed herein can be easily construed by programmers skilled in the art to which the examples pertain based on and using the flow diagrams and block diagrams of the figures and their corresponding descriptions as provided herein.

As a non-exhaustive illustration only, a terminal and a device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A source device of a wireless power transmission system, the source device comprising:
a power converter configured to generate power; and
a resonator configured to transmit the power to a target device,
wherein a ratio of an input impedance of the resonator to an output impedance of the power converter is less than a reference value.

2. The source device of claim 1, wherein:
the reference value is determined based on a power transmission efficiency of the wireless power transmission system.

3. The source device of claim 1, further comprising:
a matching network configured to perform impedance matching between the resonator and the target device based on a change in an impedance between the resonator and the target device.

4. The source device of claim 1, further comprising:
a matching network configured to perform impedance matching between the resonator and the target device to maintain a value of a voltage standing wave ratio (VSWR) between the resonator and the target device to be less than 2.

5. The source device of claim 1, wherein:
the reference value is greater than 0.5, and is less than 2.

6. The source device of claim 1, further comprising:
a matching network configured to perform impedance matching between the resonator and the target device,
wherein
in an initial condition, the matching network is further configured to maintain the input impedance of the resonator in a first quadrant or a fourth quadrant of a Smith chart, and
the initial condition indicates that the target device is recognized to be in an open state.

7. A source device of a wireless power transmission system, the source device comprising:
a power converter configured to generate a power;
a resonator configured to transmit the power to target devices; and
a matching network configured to perform impedance matching between the resonator and the target devices,
wherein a ratio of an input impedance of the resonator to an output impedance of the power converter is less than a reference value.

8. A target device of a wireless power transmission system, the target device comprising:
a resonator configured to receive and output power from a source device; and
a rectification unit configured to rectify the power output from the resonator,
wherein a ratio of an output impedance of the resonator to an input impedance of the rectification unit is less than a reference value.

9. The target device of claim 8, wherein:
the reference value is determined based on a power transmission efficiency of the wireless power transmission system.

10. The target device of claim 8, further comprising:
a matching network configured to perform impedance matching between the resonator and the source device based on a change in an impedance between the resonator and the source device.

11. The target device of claim 8, further comprising:
a matching network configured to perform impedance matching between the resonator and the source device to maintain a value of a voltage standing wave ratio (VSWR) between the resonator and the source device to be less than 2.

12. The target device of claim 8, wherein:
the reference value is greater than 0.5, and is less than 2.

13. A power transmission method of a wireless power transmission system, the power transmission method comprising:
generating, by a power converter, a power; and
transmitting, by a resonator, the power to a target device,
wherein a ratio of an input impedance of the resonator to an output impedance of the power converter is less than a reference value.

14. The power transmission method of claim 13, further comprising:
performing impedance matching between the resonator and the target device based on a change in an impedance between the resonator and the target device.

15. The power transmission method of claim 13, further comprising:
performing impedance matching between the resonator and the target device to maintain a value of a voltage standing wave ratio (VSWR) between the resonator and the target device to be less than 2.

16. The power transmission method of claim 13, wherein:
the reference value is greater than 0.5, and is less than 2.

17. The power transmission method of claim 13, further comprising:
performing impedance matching between the resonator and the target device; and
maintaining, in an initial condition, the input impedance of the resonator in a first quadrant or a fourth quadrant of a Smith chart,
wherein the initial condition indicates that the target device is recognized to be in an open state.

18. A power transmission method of a wireless power transmission system, the power transmission method comprising:
generating, by a power converter, a power;
transmitting, by a resonator, the power to target devices; and
performing impedance matching between the resonator and the target devices,
wherein a ratio of an input impedance of the resonator to an output impedance of the power converter is less than a reference value.

19. A power reception method of a wireless power transmission system, the power reception method comprising:
receiving, by a resonator, a power from a source device; and
rectifying, by a rectification unit, the received power,
wherein a ratio of an output impedance of the resonator to an input impedance of the rectification unit is less than a reference value.

20. The power reception method of claim 19, further comprising:
performing impedance matching between the resonator and the source device based on a change in an impedance between the resonator and the source device.

21. The power reception method of claim 19, further comprising:
performing impedance matching between the resonator and the source device to maintain a value of a voltage standing wave ratio (VSWR) between the resonator and the source device to be less than 2.

22. The power reception method of claim 19, wherein:
the reference value is greater than 0.5, and is less than 2.
